(19) United States
(12) Patent Application Publication
(10) Pub. No.: US 2018/0277123 A1
(43) Pub. Date: Sep. 27, 2018

(54) GESTURE CONTROLLED MULTI-PERIPHERAL MANAGEMENT

(71) Applicant: BRAGI GmbH, Munchen (DE)

(72) Inventors: Peter Vincent Boesen, München (DE); Gwenael Kosider, München (DE)

(73) Assignee: BRAGI GmbH, Munchen (DE)

(21) Appl. No.: 15/888,305

(22) Filed: Feb. 5, 2018

Related U.S. Application Data
(60) Provisional application No. 62/474,984, filed on Mar. 22, 2017.

(51) Int. Cl. G10L 17/22; G06F 3/01; H04L 29/08; G06F 3/16; H04R 1/10; G06F 21/83

(52) U.S. Cl. CPC G10L 17/22; G06F 3/017; H04L 67/125; H04W 4/80; H04R 1/1016; G06F 21/83; H04R 2420/07; G06F 3/167

(57) ABSTRACT

A method for controlling an IoT from one or more wireless earpieces in embodiments of the present invention may have one or more of the following steps: (a) associating the one or more wireless earpieces with the IoT, (b) receiving user input from a user wearing the one or more wireless earpieces, (c) sending a command to a peripheral within the IoT to execute an instruction from the one or more wireless earpieces or a wireless device linked with the one or more wireless earpieces, (d) verifying the user is authorized to utilize the peripheral, (e) associating the user input with the command, and (f) automatically connecting to the peripheral as a nearest one of a plurality of peripherals.

### PRIORITY STATEMENT

This application claims priority to U.S. Provisional Patent Application No. 62/474,984, filed on Mar. 22, 2017, titled Gesture Controlled Multi-Peripheral Management all of which is hereby incorporated by reference in its entirety.

### FIELD OF THE INVENTION

The illustrative embodiments relate to wireless earpieces. Particularly, illustrative embodiments relate to controlling peripherals utilizing wireless earpieces. More particularly, but not exclusively, the illustrative embodiments relate to a system and method of controlling an IoT utilizing wireless earpieces.

### DESCRIPTION OF THE ART

The growth of wearable devices is increasing exponentially. This growth is fostered by the decreasing size of microprocessors, circuit boards, chips, and other components. Thus far, wearable devices have been limited to basic components, functionality, and processes due to their limited footprint. Despite the size limitations, many users expect the wearables to be as convenient, reliable and functional as possible.

Smart devices provide new capabilities in our homes, such as the precise remote control of home lighting intensity and hue. Unfortunately, this increased capability comes with an attendant complexity of device control. Current methods of selecting which device to control while in motion rely on dedicated remote controls, or voice commands, or pointing within a GUI, all of which produce burdensome overhead when used in daily life. For example, it is not ideal for a person moving through their home in the evening, with family members sleeping in adjacent rooms, without a device in hand, to audibly tell their home system which lights to turn on and off. Issues may also arise upon entering a dark room containing many lights. It may be necessary to disambiguate which light is desired to be controlled, which may require a person to memorize and speak the names of the lights.

A person may hold or wear a finger-manipulated remote-control device (e.g., smartphone or smartwatch), which would require the person's eyes to guide their selection from a list or graphic of a home's lights or other Internet of Things (IoT) devices. These methods are inconvenient and are potentially dangerous when moving about in low ambient lighting. Fortunately, research has shown people may easily learn and reliably use pointing gestures to select physical objects and computer-aided tasks in the real world.

Pointing is an innate human gesture, primarily done by use of the forearm to indicate a desired pointing direction. Recently developed forearm sensor packages may be employed to determine where a person points.

Additionally, indoor location technology is increasingly accurate and convenient to install, making dense webs of environmental sensors unnecessary to determine locations of stationary or moving networked devices and users with body-mounted sensors.

Therefore, a desirable IoT device user interface (UI), one which provides the ability to select devices residing in the real world (or virtual objects and tasks displayed on a monitor) by pointing at them while in motion (e.g., walking) is technically feasible. However, issues remain with existing systems, such as indicating to a user which device has been selected.

Another challenge is how a user can select a device when it is in a crowd of devices. Crowding may be caused by devices being close to each other or appearing to from a point of view (POV). Although device location and orientation technology continue to improve, resolution between multiple distant devices remains problematic. This is a fundamental issue based on a user's perspective with respect to remote devices; even if devices are spatially separated, they may appear to overlap from certain vantage points. Increasing accuracy and precision of the location and orientation technology may not solve the issue.

### SUMMARY OF THE DISCLOSURE

Therefore, it is a primary object, feature, or advantage of the present invention to improve over the state of the art.

A method for controlling an IoT from one or more wireless earpieces in embodiments of the present invention may have one or more of the following steps: (a) associating the one or more wireless earpieces with the IoT, (b) receiving user input from a user wearing the one or more wireless earpieces, (c) sending a command to a peripheral within the IoT to execute an instruction from the one or more wireless earpieces or a wireless device linked with the one or more wireless earpieces, (d) verifying the user is authorized to utilize the peripheral, (e) associating the user input with the command, and (f) automatically connecting to the peripheral as a nearest one of a plurality of peripherals.

A wireless earpiece in embodiments of the present invention may have one or more of the following features: (a) a frame for fitting in an ear of a user, (b) a processor controlling functionality of the wireless earpiece, (c) a plurality of sensors read user input from the user, (d) a transceiver communicating with an IoT network, wherein the processor associates the wireless earpieces with an IoT, receives user input from a user wearing the wireless earpieces, and sends a command for a peripheral within the IoT to perform the command from the wireless earpieces or from a second peripheral linked with the wireless earpieces.

Wireless earpieces in embodiments of the present invention may have one or more of the following features: (a) a processor for executing a set of instructions, (b) a memory for storing the set of instructions, wherein the set of instructions are executed to: (i) associate the wireless earpieces with an IoT network, (ii) receive user input from a user wearing the wireless earpieces, and (iii) sends a command for a peripheral within the IoT network to perform the command from the wireless earpieces or a wireless device linked with the wireless earpieces.

One or more of these and/or other objects, features, or advantages of the present invention will become apparent from the specification and claims follow. No single embodiment need provide every object, feature, or advantage. Different embodiments may have different objects, features, or advantages. Therefore, the present invention is not to be limited to or by an objects, features, or advantages stated herein.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a communication environment in accordance with an illustrative embodiment;

FIG. 2 is a pictorial representation of some of the sensors of the wireless earpieces in accordance with illustrative embodiments;

FIG. 3 is a pictorial representation of a communications environment in accordance with an illustrative embodiment;

FIG. 4 is a block diagram of a wireless earpiece system in accordance with an illustrative embodiment;

FIG. 5 is a flowchart of a process for associating commands from one or more wireless earpieces with a peripheral in accordance with an illustrative embodiment;

FIG. 6 is a flowchart of a process for sending commands to the peripheral associated with the one or more wireless earpieces in accordance with an illustrative embodiment;

FIG. 7 depicts a computing system in accordance with an illustrative embodiment; and

FIG. 8 illustrates a wireless earpiece with a network for control of an IoT in an illustrative embodiment.

### DETAILED DESCRIPTION OF THE DISCLOSURE

The following discussion is presented to enable a person skilled in the art to make and use the present teachings. Various modifications to the illustrated embodiments will be plain to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of controlling peripherals utilizing wireless earpieces, it is fully contemplated embodiments of the present invention could be used in most any electronic communications device without departing from the spirit of the invention.

One embodiment of the illustrative embodiments provides a system and method for controlling a peripheral from one or more wireless earpieces. One or more wireless earpieces are associated with the peripheral. User input is received from a user wearing the one or more wireless earpieces. A command is sent for the peripheral to play content from the one or more wireless earpieces or a wireless device linked with the one or more wireless earpieces. Another embodiment provides wireless earpieces including a processor and a memory storing a set of instructions. The set of instructions are executed to perform the method described above.

Another embodiment provides a wireless earpiece. The wireless earpiece may include a frame for fitting in an ear of the user. The wireless earpiece may also include a processor controlling functionality of the wireless earpiece. The wireless earpiece may also include several sensors measuring user input from the user. The wireless earpiece may also include a transceiver communicating with at least a peripheral. The processor associates the one or more wireless earpieces with the peripheral, receives user input from a user wearing the one or more wireless earpieces, and sends a command for the peripheral to implement an action associated with the command.

Yet another embodiment provides wireless earpieces. The wireless earpieces include a processor for executing a set of instructions. The wireless earpieces include a memory for storing the set of instructions. The set of instructions are executed to associate the wireless earpieces with the peripheral, receive user input from a user wearing the wireless earpieces, and sends a command for the peripheral to play content from the wireless earpieces or a wireless device linked with the wireless earpieces.

In other embodiments, the one or more wireless earpieces may switch communications between peripherals in response to user input which may include voice commands, tactile input, head gestures, or so forth. The one or more wireless earpieces may communicate directly or indirectly with the one or more peripherals. For example, a wireless device may be utilized as an intermediary device storing the content for communication.

The illustrative embodiments provide a system, method and wireless earpieces, for managing associated or available peripheral devices. In one embodiment, the wireless earpieces may represent a set of wireless earpieces worn by a user for communications (e.g., phone or video calls), transcription, entertainment (e.g., listening to sound associated with audio, video, or other content), biometric feedback, and interaction with an application. The wireless earpieces may be associated with any number of peripherals including a wireless device, speaker, computing system, camera, gaming system, smart wearables (e.g., smart glasses, smart watches, smart jewelry, etc.), or other peripheral devices. Any number of pairing or connection processes may be utilized to associate the wireless earpieces with a peripheral or multiple peripheral.

The wireless earpieces may connect to one or more peripherals as an end-device or as an intermediary-device. For example, an associated wireless device may be utilized as a management device, repeater, range extender, signal booster, or so forth. In one embodiment, the wireless earpieces may control a smart phone linked or synchronized with a wireless speaker. As a result, the smart phone may act as an intermediary device managed by the wireless earpieces to control playback of audio, video, data, files, or another media content. The wireless device may have additional logic and resources available utilized by the wireless earpieces. The wireless earpieces may include data, files, and other information accessed, played, communicated, and otherwise managed by the wearing user. For example, the wireless earpieces may store any number of music files sent, streamed, or played through one or more associated wireless devices, such as a smart phone and wireless speaker.

The wireless earpieces may include any number of sensors. The sensors may be utilized to sense user input, feedback, and commands. The user input may be received utilizing voice commands, tactile input, head motions, gestures, biometrics or other input. The commands may also represent a combination of user inputs utilized to ensure the peripheral action is only performed as desired by the user. The wireless earpieces may communicate utilizing any number of transceivers. For example, the wireless earpieces may communicate utilizing NFMI. The wireless earpieces may also communicate utilizing Bluetooth, Wi-Fi, cellular, or other transceivers. The transceivers of the wireless earpieces may utilize distinct modes, channels, stacks, interfaces or hardware to enable communications between the wireless earpieces, an associated wireless device, peripherals, and so forth. In some embodiments, the wireless earpieces may not include sensors or may only include minimal sensors. For example, physical touch buttons or switches may be utilized to receive user input or feedback.

The one or more wireless earpieces are trained to associate a command with an action implemented by the peripheral. The training process may ensure the desired command is implemented by a desired user at a desired time. For example, the user may be required to perform the user input several times before the wireless earpieces are fully trained. As a result, once the command is received (or detected) by the one or more wireless earpieces, the wireless earpieces may determine the applicable action associated with the command and send it to the selected peripheral. In some embodiments, the wireless earpieces may format the command to be understood and implemented by the peripheral device. The wireless earpieces may also utilize standard commands and interactions for managing the one or more associated or available peripherals.

Examples of peripherals may include smart phones, wireless speakers, smart assistant devices, cameras, gaming devices, augmented reality systems, wearables (e.g., smart watches, smart glasses, smart jewelry, etc.), medical implants, vehicle systems, smart homes and so forth. The wireless earpieces may connect with the peripherals utilizing any number of factors, such as proximity, pairing (perform previously or at time), user input or gestures, user preferences or settings or so forth.

The wireless earpieces may act as an input/output device for providing voice, gesture, touch, or other input to control, manage, or interact with the peripherals. The wireless earpieces may operate actively or passively to perform any number of tasks, features, and functions based on commands, user preferences, or so forth. The wireless earpieces, methods, and described embodiments may represent hardware, software, firmware, or a combination thereof. The wireless earpieces may also be an integrated part of a virtual reality or augmented reality system. The wireless earpieces may also perform biometric and environmental measurements for a user. The measurements may be logged, streamed, played to the user, or otherwise communicated or saved.

Each of the wireless earpieces may be utilized to play music or audio, track user biometrics, perform communications (e.g., two-way, alerts, etc.), provide feedback/input, or any number of other tasks. The wireless earpieces may manage execution of software or sets of instructions stored in an on-board memory of the wireless earpieces to accomplish numerous tasks. As noted, the wireless earpieces may be utilized to control, communicate, manage, or interact with several other computing peripherals, communications peripherals, or wearable device peripherals, such as smart phones, laptops, personal computers, tablets, holographic displays, virtual reality systems, gaming devices, projection systems, vehicles, smart glasses, helmets, smart glass, watches or wrist bands, chest straps, implants, displays, clothing, smart assistants (e.g., Alexa®, Cortana®, Siri®, or Google Home®) or so forth are generally referred to as peripherals herein. In one embodiment, the wireless earpieces may be integrated with, control, or otherwise communicate with a personal area network. A personal area network is a network for data transmissions among devices, such as personal computing, communications, camera, vehicles, entertainment, and medical devices. The personal area network may utilize any number of wired, wireless, or hybrid configurations and may be stationary or dynamic. For example, the personal area network may utilize wireless network protocols or standards, such as INSTEON, IrDA, Wireless USB, near field magnetic induction (NFMI), Bluetooth, Z-Wave, ZigBee, Wi-Fi, ANT+ or other applicable radio frequency signals. In one embodiment, the personal area network may move with the user.

As noted, the wireless earpieces may include any number of sensors for reading user biometrics, such as pulse rate, blood pressure, blood oxygenation, temperature, orientation, movement, actions, activities, calories expended, blood or sweat chemical content, voice and audio output, impact levels, and orientation (e.g., body, head, etc.). The sensors may also determine the user's location, position, velocity, impact levels, and so forth. The sensors may also receive user input and convert the user input into commands or selections made across the peripherals of the personal area network. For example, the user input detected by the wireless earpieces may include voice commands, head motions, finger taps, finger swipes, motions or gestures, or other user inputs sensed by the wireless earpieces. The user input may be received, parsed, and converted into commands associated with the input utilized internally by the wireless earpieces or sent to one or more external peripheral devices. The wireless earpieces may perform sensor measurements for the user to read any number of user biometrics. The user biometrics may be analyzed including measuring deviations or changes of the sensor measurements over time, identifying trends of the sensor measurements, and comparing the sensor measurements to control data for the user.

The wireless earpieces may also measure environmental conditions, such as temperature, location, barometric pressure, humidity, radiation, wind speed, and other applicable environmental data. The wireless earpieces may also communicate with external devices to receive additional sensor measurements. The wireless earpieces may communicate with external devices to receive available information, which may include information received through one or more networks, such as the Internet. The detection of biometrics and environmental information may be enhanced utilizing each of the wireless earpieces of a set as a measurement device. In addition, the separate measurements may be utilized for mapping or otherwise distinguishing applicable information.

The wireless earpieces may also control peripheral devices through an IoT network. The Internet of things (IoT) is the network of physical devices, vehicles, home appliances and other items embedded with electronics, software, sensors, actuators, and network connectivity which enables these objects to connect and exchange data. Each thing is uniquely identifiable through its embedded computing system but can inter-operate within the existing Internet infrastructure. The IoT allows objects to be sensed or controlled remotely across existing network infrastructure, creating opportunities for more direct integration of the physical world into computer-based systems, and resulting in improved efficiency, accuracy and economic benefit in addition to reduced human intervention. When IoT is augmented with sensors and actuators, the technology becomes an instance of the more general class of cyber-physical systems, which also encompasses technologies such as smart grids, virtual power plants, smart homes, intelligent transportation and smart cities.

“Things”, in the IoT sense, can refer to a wide variety of devices such as heart monitoring implants, biochip transponders on farm animals, cameras streaming live feeds of wild animals in coastal waters, automobiles with built-in sensors, DNA analysis devices for environmental/food/pathogen monitoring, or field operation devices assisting firefighters in search and rescue operations. These devices collect useful data with the help of various existing technologies and then autonomously flow the data between other devices.

The wireless earpieces may also utilize edge computing to make operation efficient and seamless. Edge computing is a method of optimizing cloud-computing systems by performing data processing at the edge of the network, near the source of the data. This reduces the communications bandwidth needed between sensors and the central data center by performing analytics and knowledge generation at or near the source of the data. This approach requires leveraging resources not continuously connected to a network such as laptops, smartphones, tablets and sensors. Edge computing covers a wide range of technologies including wireless sensor networks, mobile data acquisition, mobile signature analysis, cooperative distributed peer-to-peer ad-hoc networking and processing also classifiable as local cloud/fog computing and grid/mesh computing, dew computing, mobile edge computing, cloudlet, distributed data storage and retrieval, autonomic self-healing networks, remote cloud services, augmented reality, and more.

Edge computing pushes applications, data and computing power (services) away from centralized points to the logical extremes of a network. Edge computing replicates fragments of information across distributed networks of web servers, which may spread over a vast area. As a technological paradigm, edge computing is also referred to as mesh computing, peer-to-peer computing, autonomic (self-healing) computing, grid computing and by other names implying non-centralized, node-less availability.

Edge application services significantly decrease the volumes of data moved, the consequent traffic, and the distance the data must travel, thereby reducing transmission costs, shrinking latency, and improving quality of service (QoS). Edge computing eliminates, or at least de-emphasizes, the core computing environment, limiting or removing a major bottleneck and a potential point of failure. Security improves as encrypted data moves further in, toward the network core. As it approaches the enterprise, data is checked as it passes through protected firewalls and other security points, where viruses, compromised data, and active hackers can be caught early. The ability to “virtualize” (i.e., logically group CPU capabilities on an as-needed, real-time basis) extends scalability. ISO/IEC 20248 provides a method whereby the data of objects identified by edge computing using Automated Identification Data Carriers [AIDC], a barcode and/or RFID tag, can be read, interpreted, verified and made available into the “Fog” and on the “Edge” even when the AIDC tag has moved on.

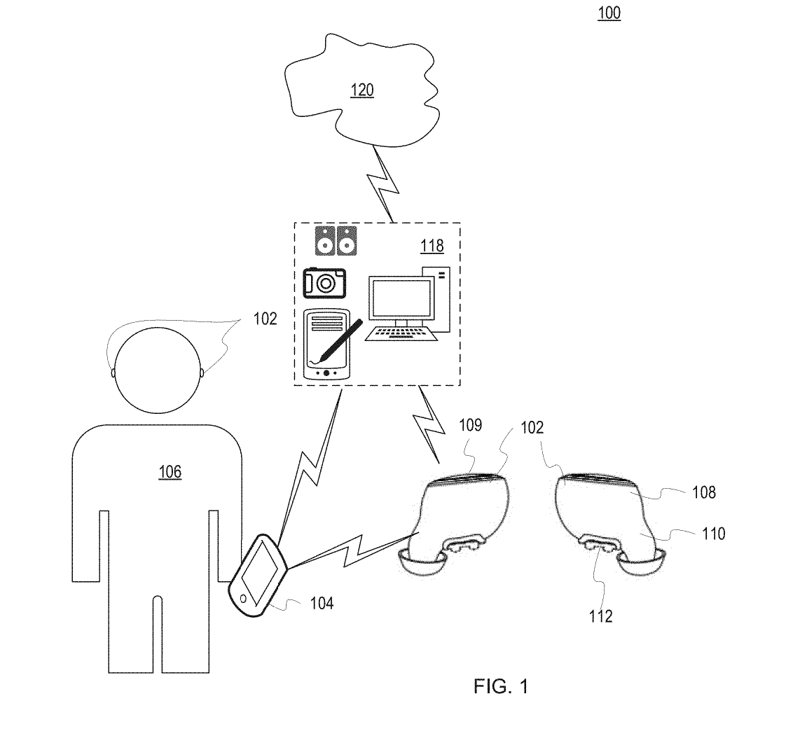

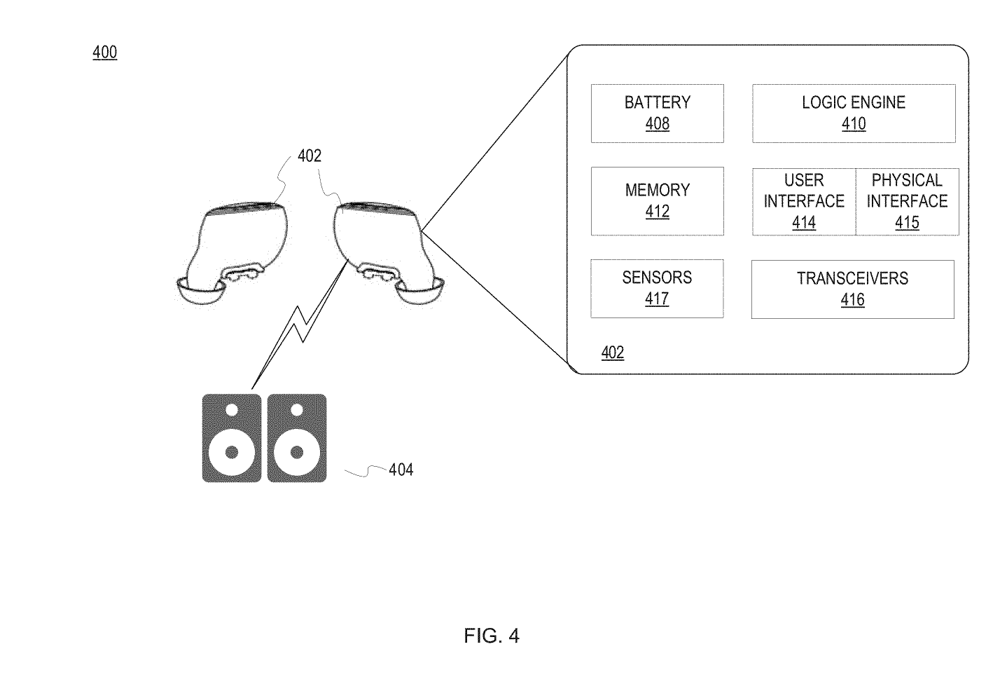

FIG. 1 is a pictorial representation of a communications environment 100 in accordance with an illustrative embodiment. The wireless earpieces 102 may be configured to communicate with each other and with one or more peripherals, such as a wireless device 104, or other peripherals 118. The wireless earpieces 102 may be worn by a user 106 and are shown both as worn and separately from their positioning within the ears of the user 106 for purposes of visualization. A block diagram of the wireless earpieces 102 is further shown in FIG. 4 to illustrate components and operation of the wireless earpieces 102. As subsequently described, the wireless earpieces 102 may be utilizing networks to control actions performed by the peripherals 118. As a result, the wireless earpieces 102 may control the peripherals 118 directly, through one or more networks or through one or more other peripherals 118. Wireless earpieces 102 are an ear bud or in-the-ear earpieces and designed to be worn inside of the ear.

In one embodiment, the wireless earpieces 102 includes a frame 108 shaped to fit substantially within the ears of the user 106. The frame 108 is a support structure at least partially enclosing and housing the electronic components of the wireless earpieces 102. The frame 108 may be composed of a single structure or multiple interconnected structures. An exterior portion of the wireless earpieces 102 may include a first set of sensors shown as infrared sensors 109. The infrared sensors 109 may include emitter and receivers detecting and measuring infrared light radiating from objects in their field of view. The infrared sensors 109 may detect gestures, touches, or other user input against an exterior portion of the wireless earpieces 102 visible when worn by the user 106. The infrared sensors 109 may also detect infrared light or motion. The infrared sensors 109 may be utilized to determine whether the wireless earpieces 102 are being worn, moved, approached by a user, set aside, stored in a smart case, placed in a dark environment, or so forth.

The frame 108 defines an extension 110 configured to fit substantially within the ear of the user 106. The extension 110 may include one or more speakers or vibration components for interacting with the user 106. The extension 110 may be removably covered by one or more sleeves or speaker covers. The sleeves may be changed to fit the size and shape of the user's ears. The sleeves may come in various sizes and have extremely tight tolerances to fit the user 106 and one or more other users may utilize the wireless earpieces 102 during their expected lifecycle. In another embodiment, the sleeves may be custom built to support the interference fit utilized by the wireless earpieces 102 while also being comfortable while worn. The sleeves are shaped and configured to not cover various sensor devices of the wireless earpieces 102. Separate sleeves may be utilized if different users are wearing the wireless earpieces 102.

In one embodiment, the frame 108 or the extension 110 (or other portions of the wireless earpieces 102) may include sensors 112 for sensing pulse, blood oxygenation, temperature, voice characteristics, skin conduction, glucose levels, impacts, activity level, position, location, orientation, as well as any number of internal or external user biometrics. In other embodiments, the sensors 112 may be positioned to contact or be proximate the epithelium of the external auditory canal or auricular region of the user's ears when worn. For example, the sensors 112 may represent various metallic sensor contacts, optical interfaces, or even micro-delivery systems for receiving, measuring, and delivering information and signals. Small electrical charges or spectroscopy emissions (e.g., various light wavelengths) may be utilized by the sensors 112 to analyze the biometrics of the user 106 including pulse, blood pressure, skin conductivity, blood analysis, sweat levels, and so forth. In one embodiment, the sensors 112 may include optical sensors emitting and measuring reflected light within the ears of the user 106 to measure any number of biometrics. The optical sensors may also be utilized as a second set of sensors to determine when the wireless earpieces 102 are in use, stored, charging, or otherwise positioned.

The sensors 112 may be utilized to provide relevant information communicated through audio, tactile, and other interfaces of the wireless earpieces 102. As described, the sensors 112 may include one or more microphones integrated with the frame 108 or the extension of the wireless earpieces 102. For example, an external microphone may sense environmental noises as well as the user's voice as communicated through the air of the communications environment 100. An ear-bone or internal microphone may sense vibrations or sound waves communicated through the head of the user 102 (e.g., bone conduction, etc.). In other embodiments, the wireless earpieces 102 may not have sensors 112 or may have very limited sensors.

In some applications, temporary adhesives or securing mechanisms (e.g., clamps, straps, lanyards, extenders, wires, etc.) may be utilized to ensure the wireless earpieces 102 remain in the ears of the user 106 even during the most rigorous and physical activities or to ensure they do fall out, get lost or become broken. For example, the wireless earpieces 102 may be utilized during marathons, swimming, dancing, action sport photo shoots, team sports, biking, hiking, parachuting, or so forth. The wireless earpieces 102 may be utilized to control the peripherals 118 during any number of activities including, but not limited to, sports, leisure activities, communications, recreational activities, business, military operations, training exercises, or so forth. In one embodiment, miniature straps may attach to the wireless earpieces 102 with a clip on the strap securing the wireless earpieces to the clothes, hair, or body of the user.

The wireless earpieces 102 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless earpieces 102 may also execute any number of applications to perform specific purposes. For example, a peripheral control application may control interpretation, communication, training, and implementation of commands sent between the wireless earpieces 102 and one or more of the peripherals 119. The wireless earpieces 102 may be utilized with any number of automatic assistants, such as Siri, Cortana, Alexa, Google, Watson, or other smart assistants/artificial intelligence systems.

In one embodiment, the communications environment 100 may further include a personal computer (shown as one of the peripherals 118). The peripherals 118 may communicate with one or more wired or wireless networks, such as a network 120. The peripherals 118 may represent any number of devices, systems, equipment, or components, such as a laptop, server, wireless speaker, camera, optics system, tablet, medical system, gaming device, virtual/augmented reality system, or so forth. The peripherals 118 may communicate utilizing any number of standards, protocols, or processes. For example, the peripherals 118 may utilize a wired or wireless connection to communicate with the wireless earpieces 102, the wireless device 104, or other electronic devices. The peripherals 118 may utilize any number of memories or databases to store or synchronize biometric information associated with the user 106, data, passwords or media content. In one embodiment, the peripherals 118 may execute a program for associating user actions with commands received to implement user-specified actions. The application (or versions of it) may be executed across any of the devices of the communications environment 100.

The wireless earpieces 102 may determine their position with respect to each other as well as the peripherals 118. For example, position information for the wireless earpieces 102 and each of the peripherals 118 may determine proximity of the devices in the communications environment 100. For example, global positioning information, signal quality, or signal strength/activity may be utilized to determine proximity and distance of the devices to each other in the communications environment 100. In one embodiment, the distance information may be utilized to determine whether commands may be implemented between the devices. For example, the wireless earpieces 102 may be required to be within thirty feet of the wireless device 104 for the peripherals 118 to implement a command. The transmission power or amplification of received signals may also be varied based on the proximity of the devices in the communications environment 100. For example, if different users are wearing the wireless earpieces 102, the signal strength may be increased or decreased based on the relative distance between the wireless earpieces 102 to enable communications with one another or one of the peripherals 119.

In one embodiment, the wireless earpieces 102 and the corresponding sensors 112 (whether internal or external) may be configured to take several measurements or log information and activities during normal usage. This information, data, values, and determinations may be reported to the user(s) or otherwise utilized. The sensor measurements may be utilized to extrapolate other measurements, factors, or conditions applicable to the user 106 or the communications environment 100. For example, the sensors 112 may be utilized to associate user input, with specified commands sent to one or more of the peripherals 118 for implementation as specific actions. The user 106 or another party may configure the wireless earpieces 102 directly or through a connected device and app (e.g., mobile app with a graphical user interface) to set peripheral input, commands, authorized peripherals/users, peripheral actions, or other settings (e.g., preferences, conditions, parameters, settings, factors, etc.).

For example, the user may specify proximity thresholds for automatically connecting to each of the peripherals 118. The user may also specify the user input may be utilized to connect the wireless earpieces 102 to the wireless device 104 or the peripherals 118. For example, a head nod in the direction of one of the peripherals 118 may be detected by the sensors 112 (e.g., accelerometers, gyroscopes, etc.) of the wireless earpieces 102. In another example, a specific verbal command given by the user 106 may be utilized to connect to one or more of the peripherals 118. For example, the user 106 may state “connect to my wireless speaker” to connect to, link with, or otherwise communicate with a wireless speaker, such as a portable Bluetooth speaker. Any number of other commands, user input, feedback, or user biometrics may be measured by the sensors 112 to connect with one of the associated peripherals 118.

In one embodiment, the user 106 may set the conditions enabling the wireless earpieces 102 to listen for user input/commands. For example, a key word, head nod, double tap to one of the wireless earpieces, or so forth may prepare the wireless earpieces 102 and/or the peripherals 118 to receive, process, and send a command. In another embodiment, the user may establish the light conditions, motion or other factors activating the listening (or full power mode) or may alternatively keep the wireless earpieces 102 in a sleep or low power mode. As a result, the user 106 may configure the wireless earpieces 102 to maximize the processor resources and battery life based on motion, lighting conditions, and other factors established for the user 106. For example, the user 106 may set the wireless earpieces 102 to enter a listening mode only if positioned within the ears of the user 106 within ten seconds of being moved, otherwise the wireless earpieces 102 remain in a low power mode to preserve battery life. This setting may be particularly useful if the wireless earpieces 102 are periodically moved or jostled without being inserted into the ears of the user 106.

In one example, the user 106 or another party may also utilize the wireless device 104 to associate user information and conditions with the user preferences. For example, an application executed by the wireless device 104 (or peripherals 118) may be utilized to specify the conditions enabling the wireless earpieces 102 to automatically or manually communicate commands to the peripherals 118. In addition, the enabled components and functions (e.g., sensors, transceivers, vibration alerts, speakers, lights, etc.) may be selectively activated based on the user preferences as set by default, by the user, or based on historical information. In another embodiment, the wireless earpieces 102 may be adjusted or trained over time to become even more accurate in adjusting to habits, requirements, requests, activations, processes, or functions. For example, in response to detecting the wireless earpieces 102 are worn by a first user a first set of trained commands may be available to the first user for a first specified group of the peripherals 118. When a second user wears the wireless earpieces 102, a second set of trained commands may be available for implementation by the user with a second specified group of the peripherals 119. The wireless earpieces 102 may utilize historical information to generate default values, baselines, thresholds, policies, or settings for determining when and how the wireless earpieces 102 (or a virtual assistant of the wireless earpieces 102) perform various communications, actions, and processes. As a result, the wireless earpieces 102 may effectively manage the automatic and manually performed processes of the wireless earpieces 102 based on automatic detection of events and conditions (e.g., light, motion, user sensor readings, etc.) and user specified settings and preferences.

The wireless earpieces 102 may include any number of sensors 112 and logic for measuring and determining user biometrics, such as pulse rate, skin conduction, blood oxygenation, temperature, calories expended, blood or excretion chemistry, voice and audio output, hand or head gestures, position, and orientation (e.g., body, head, etc.). The sensors 112 may also determine the user's location, position, velocity, impact levels, and so forth. Any of the sensors 112 may be utilized to detect or confirm light, motion, or other parameters affecting how the wireless earpieces 102 manage, utilize and initialize the peripherals 118. The sensors 112 may also receive user input and convert the user input into commands or selections made across the peripherals 118 or other personal devices of the personal area network. For example, the user input detected by the wireless earpieces 102 may include voice commands, head motions, finger taps, finger swipes, motions or gestures, or other user inputs sensed by the wireless earpieces 102. The user input may be determined by the wireless earpieces 102 and converted into authorization commands may be sent to one or more external devices, such as the wireless device 104, the peripherals 119, secondary wireless earpieces, or so forth. For example, the user 106 may create a specific head motion and voice command when detected by the wireless earpieces 102 are utilized to send a request or command to the wireless device 104, such as “report my current heart rate, speed, and location.” Any number of actions may also be implemented by the logic, applications, or virtual assistant of the wireless earpieces 102 in response to specified user input.

The sensors 112 may make all or a portion of the measurements regarding the user 106 and communications environment 100. The sensors 112 of the wireless earpieces 102 may also communicate with any number of other sensory devices, components, or systems in the communications environment 100 (e.g., sensors of the wireless device 104, peripherals 118, etc.). In one embodiment, the communications environment 100 may represent all or a portion of a personal area network. The wireless earpieces 102 may be utilized to control, communicate, manage, or interact with several other wearable devices or electronics, such as smart glasses, helmets, smart glass, watches or wrist bands, other wireless earpieces, chest straps, implants, displays, clothing, or so forth. A personal area network is a network for data transmissions among devices, components, equipment, and systems, such as personal computers, communications devices, cameras, vehicles, entertainment/media devices, and medical devices. The personal area network may utilize any number of wired, wireless, or hybrid configurations and may be stationary or dynamic. For example, the personal area network may utilize wireless network protocols or standards, such as INSTEON, IrDA, Wireless USB, Bluetooth, Z-Wave, ZigBee, Wi-Fi, ANT+ or other applicable radio frequency signals. In one embodiment, the personal area network may move with the user 106.

In other embodiments, the communications environment 100 may include any number of devices, components, or so forth communicating with each other directly or indirectly through a wireless (or wired) connection, signal, or link. The communications environment 100 may include one or more networks and network components and devices represented by the network 120, such as routers, servers, signal extenders, intelligent network devices, computing devices, or so forth. In one embodiment, the network 120 of the communications environment 100 represents a personal area network as previously disclosed. In one embodiment, the virtual assistants of the various devices of the communications environment may be utilized to send, receive, and process commands and the associated actions. For example, a virtual assistant of the wireless earpieces 102 may process commands to stream audio content stored on the wireless earpieces 102 through the wireless device 104 (as an intermediary device) to one of the peripherals 118, such as a wireless speaker. In one embodiment, communications environment 100 could be an IoT network of physical devices (e.g., such as peripherals 118, wireless device 104 and wireless earpieces 102) where a user can control one or more physical devices utilizing the wireless devices through the IoT network connectivity. In one embodiment, the IoT network of physical devices all have a computing system similar to the computing system 700 in order to carry out edge computing or a form of edge computing where each deivce of the physical devices can perform processing of data at the physical device to reduce data bandwidth issues and make the IoT network more effiecient.

Communications within the communications environment 100 may occur through the network 120 or a Wi-Fi network or may occur directly between devices, such as the wireless earpieces 102 and the wireless device 104. The network 120 may communicate with or include a wireless network, such as a Wi-Fi, cellular (e.g., 3G, 4G, 5G, PCS, GSM, etc.), Bluetooth, or other short range or long-range radio frequency networks, signals, connections, or links. The network 120 may also include or communicate with any number of hard wired networks, such as local area networks, coaxial networks, fiber-optic networks, network adapters, Internet or so forth. Communications within the communications environment 100 may be operated by one or more users, service providers, or network providers.

The wireless earpieces 102 may play, display, communicate, or utilize any number of alerts or communications to indicate the commands, actions, activities, communications or status in use or being implemented by the wireless earpieces 102 or the corresponding peripherals 118. For example, one or more alerts may indicate when the wireless earpieces 102 are being utilized with the wireless device 104, such as “audio streaming is activated”, “biometric reporting to an external speaker is enabled”, “audio paused”, “command initiated on the ______”, and so forth. The alerts may include any number of tones, verbal acknowledgements, tactile feedback, or other forms of communicated messages. For example, an audible alert and LED flash may be utilized each time one of the wireless earpieces 102 receives a command for processing and communication to the associated wireless device 104. Verbal or audio acknowledgements, answers, and actions utilized by the wireless earpieces 102 are particularly effective because of user familiarity with such devices in standard smart phone and personal computers. The corresponding alert may also be communicated to the user 106, the wireless device 104, peripherals 118 and the personal computer.

In other embodiments, the wireless earpieces 102 may also vibrate, flash, play a tone or other sound, or give other indications of the actions, status, or processes being implemented. The wireless earpieces 102 may also communicate an alert to the wireless device 104 showing up as a notification, message, in-app alert or other indicator indicating changes in status, commands, communications, actions, or so forth.

The wireless earpieces 102, the wireless device 104, or the peripherals 118 themselves may include logic for automatically implementing peripheral management in response to motion, light, user activities, user biometric status, user location, user position, historical activity/requests, or various other conditions and factors of the communications environment 100. During a peripheral command mode, the wireless earpieces 102 may be activated to perform a specified activity or to “listen” or be prepared to “receive” user input, feedback, or commands for implementation by the peripherals 118.

The wireless device 104 and peripherals 118 may represent any number of wireless or wired electronic devices, such as cameras, biometric trackers, remote initiation systems, virtual assistants, appliances, smart phones, laptops, desktop computers, control systems, tablets, displays, gaming devices, music players, personal digital assistants, vehicle systems, or so forth. The wireless device 104 and peripherals 118 may communicate utilizing any number of wireless connections, standards, or protocols (e.g., near field communications, NFMI, Bluetooth, Wi-Fi, wireless Ethernet, etc.). For example, the wireless device 104 may be a touch screen smart phone communicating with the wireless earpieces 102 utilizing Bluetooth communications. In another example, one of the peripherals 118 may represent a speaker, such as a high-end professional Bluetooth speaker for entertainment. In another example, one of the peripherals 118 may represent a camera, such as a high-end professional or amateur camera, cell phone camera, GoPro™, trail camera, body camera, wearable camera, or so forth. The wireless device 104 or peripherals 118 may implement and utilize any number of operating systems, kernels, instructions, or applications may make use of the available sensor data sent from the wireless earpieces 102. For example, the wireless device 104 and peripherals 118 may represent any number of android, iOS, Windows, Linux, Unix, open platforms, or other systems and devices. Similarly, the wireless device 104 or the wireless earpieces 102 may execute any number of standard or specialized applications utilize the user input, proximity data, biometric data, and other feedback from the wireless earpieces 102 to initiate, authorize, or perform the associated tasks.

As noted, the layout of the internal components of the wireless earpieces 102 and the limited space available for a product of limited size may affect where the sensors 112 may be positioned. The positions of the sensors 112 within each of the wireless earpieces 102 may vary based on the model, version, and iteration of the wireless earpieces 102 design and manufacturing process. In one embodiment, the wireless earpieces 102 may not include any or all the sensors 112. In addition, instead of infrared, optical, or capacitive sensors, the wireless earpieces 102 may utilize push buttons for receiving user input. The wireless earpieces 102 may also represent headphones.

In other embodiments, the wireless earpieces 102 may take the shape and format of on-ear or over-hear headphones. For example, the wireless earpieces 102 may represent headphones. In another example, the wireless earpieces 102 may be docked in headphones (e.g., available earpiece ports or interfaces) to provide enhanced audio to the user. The headphones may include additional batteries, processors, amplifiers, speakers, and so forth further enhancing the components and functionality of the wireless earpieces 102.

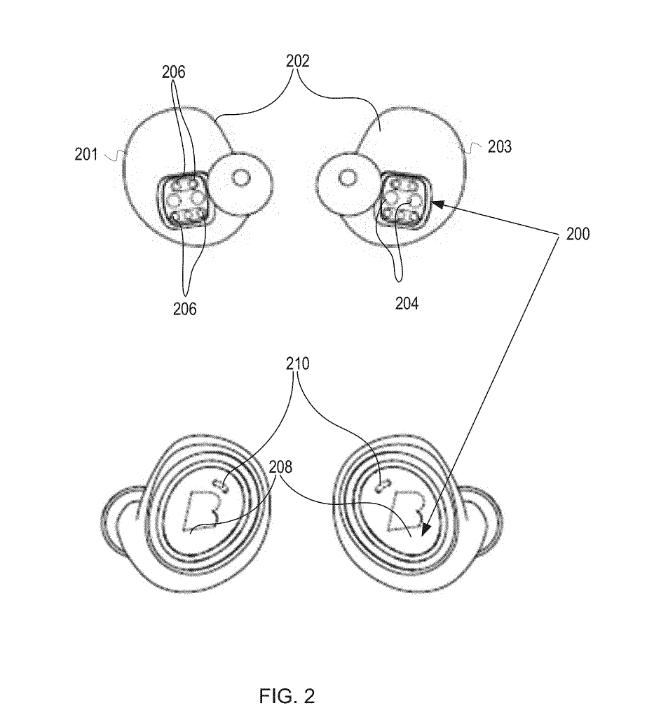

FIG. 2 is a pictorial representation of some of the sensors 200 of the wireless earpieces 202 in accordance with illustrative embodiments. As shown the wireless earpieces 202 may include a left wireless earpiece 201 and a right wireless earpiece 203 representative of a set of wireless earpieces. In other embodiments, a set of wireless earpieces may include several left wireless earpieces 201 and right wireless earpieces 203. The illustrative embodiments may also be applicable to large numbers of wireless earpieces and may communicate directly or indirectly (e.g., Wi-Fi, mesh networking, etc.) with each other a wireless hub/wireless device or so forth.

As previously noted, the wireless earpieces 202 may include any number of internal or external sensors. In one embodiment, the sensors 200 may be utilized to determine environmental information and whether the wireless earpieces 202 are being utilized by different users. Similarly, any number of other components or features of the wireless earpieces 202 may be managed based on the measurements made by the sensors 200 to preserve resources (e.g., battery life, processing power, etc.). The sensors 200 may make independent measurements or combined measurements utilizing the sensory functionality of each of the sensors 200 to measure, confirm, or verify sensor measurements.

In one embodiment, the sensors 200 may include optical sensors 204, contact sensors 206, infrared sensors 208, and microphones 210. The optical sensors 204 may generate an optical signal communicated to the ear (or other body part) of the user and reflected. The reflected optical signal may be analyzed to determine blood pressure, pulse rate, pulse oximetry, vibrations, blood chemistry, and other information about the user. The optical sensors 204 may include any number of sources for outputting various wavelengths of electromagnetic radiation and visible light. Thus, the wireless earpieces 202 may utilize spectroscopy as it is known in the art and developing to determine any number of user biometrics.

The optical sensors 204 may also be configured to detect ambient light proximate the wireless earpieces 202. In one embodiment, the optical sensors 204 may also include an externally facing portion or components. For example, the optical sensors 204 may detect light and light changes in an environment of the wireless earpieces 202, such as in a room where the wireless earpieces 202 are located. The optical sensors 204 may be configured to detect any number of wavelengths including visible light may be relevant to light changes, approaching users or devices, and so forth.

In another embodiment, the contact sensors 206 may be utilized to determine the wireless earpieces 202 are positioned within the ears of the user. For example, conductivity of skin or tissue within the user's ear may be utilized to determine the wireless earpieces are being worn. In other embodiments, the contact sensors 206 may include pressure switches, toggles, or other mechanical detection components for determining the wireless earpieces 202 are being worn. The contact sensors 206 may measure or provide additional data points and analysis indicating the biometric information of the user. The contact sensors 206 may also be utilized to apply electrical, vibrational, motion, or other input, impulses, or signals to the skin of the user. The contact sensors 206 may be internally or externally positioned. For example, external pushbuttons may be utilized to receive commands, instructions, or feedback related to the performance of the wireless earpieces 202.

The wireless earpieces 202 may also include infrared sensors 208. The infrared sensors 208 may be utilized to detect touch, contact, gestures, or another user input. The infrared sensors 208 may detect infrared wavelengths and signals. In another embodiment, the infrared sensors 208 may detect visible light or other wavelengths as well. The infrared sensors 208 may be configured to detect light or motion or changes in light or motion. Readings from the infrared sensors 208 and the optical sensors 204 may be configured to detect light or motion. For example, a hand gesture made in front of the wireless earpieces 202 may be detected and determined to be a command for an associated peripheral. The readings may be compared to verify or otherwise confirm light or motion. As a result, decisions regarding user input, biometric readings, environmental feedback, and other measurements may be effectively implemented in accordance with readings from the sensors 200 as well as other internal or external sensors and the user preferences. The infrared sensors 208 may also be integrated in the optical sensors 204.

The wireless earpieces 210 may include microphones 210. The microphones 210 may represent external microphones as well as internal microphones. The external microphones may be positioned exterior to the body of the user as worn. The external microphones may sense verbal or audio input, feedback, and commands received from the user. The external microphones may also sense environmental, activity, and external noises and sounds. The internal microphone may represent an ear-bone or bone conduction microphone. The internal microphone may sense vibrations, waves or sound communicated through the bones and tissue of the user's body (e.g., skull). The microphones 210 may sense content is utilized by the wireless earpieces 202 to implement the processes, functions and methods herein described. The audio input sensed by the microphones 210 may be filtered, amplified or otherwise processed before or after being sent to the logic of the wireless earpieces 202. The processed user input from the microphones 210 may be processed to determine the command, associated peripheral, peripheral action and communications process for communicating the command to the peripheral.

In another embodiment, the wireless earpieces 202 may include chemical sensors (not shown) performing chemical analysis of the user's skin, excretions, blood or any number of internal or external tissues or samples. For example, the chemical sensors may determine whether the wireless earpieces 202 are being worn by the user. The chemical sensor may also be utilized to monitor important biometrics more effectively read utilizing chemical samples (e.g., sweat, blood, excretions, etc.). In one embodiment, the chemical sensors are non-invasive and may only perform chemical measurements and analysis based on the externally measured and detected factors. In other embodiments, one or more probes, vacuums, capillary action components, needles, or other micro-sampling components may be utilized. Minute amounts of blood or fluid may be analyzed to perform chemical analysis reported to the user and others. The sensors 200 may include parts or components periodically replaced or repaired to ensure accurate measurements. In one embodiment, the infrared sensors 208 may be a first sensor array and the optical sensors 204 may be a second sensor array.

In other embodiments, the wireless earpieces 202 may include radar or LIDAR sensors for mapping the user's ear, head, and body. The radar and/or LIDAR sensors may also measure and map an environment associated with the wireless earpieces 202 in real-time or near real-time. The transceivers of the wireless earpieces 202 may also act as a sensor for determining proximity of the wireless earpieces 202 to associated wireless devices, peripherals, other wireless earpieces, users and so forth. For example, signal strength, absorption, reflection, and so forth may be utilized to determine distances, orientation, and location of the wireless earpieces 202 as well as the external devices and objects as noted above.

Any of the sensors 200 of the wireless earpieces 202 may measure user input and commands utilized to control associated peripheral devices. The sensors may be utilized individually or in combination to most effectively detect and process commands from the user.

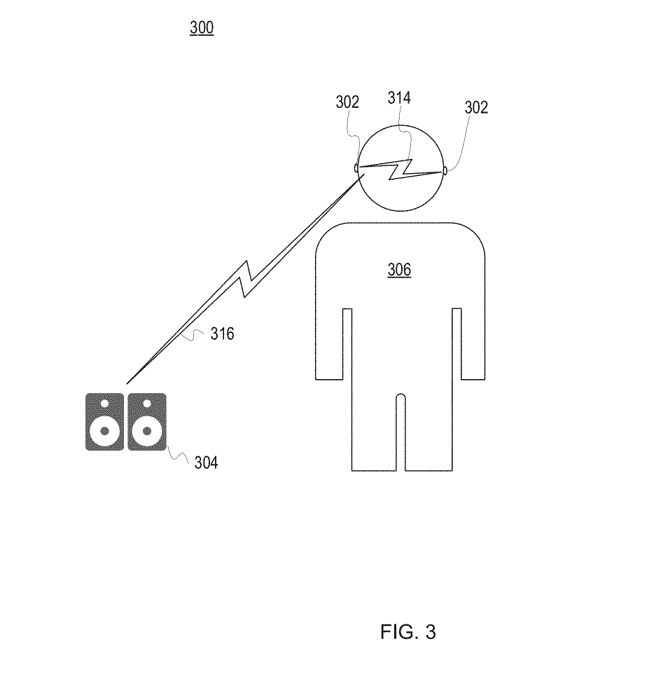

FIG. 3 is a pictorial representation of another communications environment 300 in accordance with an illustrative embodiment. In one embodiment, the communications environment 300 may include wireless earpieces 302 communicating with a peripheral 304. The peripheral 304 may represent a peripheral as described herein, such as a wireless speaker. The wireless earpieces 302 may be utilized by a first user 306. The set of wireless earpieces 302 may include a first wireless earpiece and a second wireless earpiece, such as a left wireless earpiece and a right wireless earpiece.

In one embodiment, the communications environment 300 represents utilization of the wireless earpieces 302 to communicate with the peripheral 304. The communications environment 300 further illustrates a wireless connection 314 between the wireless earpieces 302 and a wireless connection 316 between one or more of the wireless earpieces 302 and the peripheral 304.

Commands to the wireless earpieces 302 may be utilized to provide hands-free input to the peripheral 304. As a result, commands or processes may be more effectively implemented by the peripheral 304. In one example, input received by the wireless earpieces 302 may be utilized to play media content (e.g., audio content, audio associated with video, etc.) using the peripheral 304. As a result, the user 306 may operate the peripheral in a hands-free manner. For example, the user 306 may be able to connect to the peripheral 304 by nodding in the direction of the peripheral. In another example, the user 306 may say “connect to my Bluetooth speaker” to connect to the peripheral 304. In yet another example, the wireless earpieces 302 may automatically connect to the peripheral 304 in response to determining the user 306 is proximate the peripheral 304 and the peripheral 304 is on, available, or otherwise ready to be accessed. Content may be communicated to the peripheral 304 directly through the connection 316 or indirectly through one or more associated wireless devices (not shown), such as a smart phone. As a result, the user 306 may be able to more effectively utilize the wireless earpiece 302 as well as the peripheral 304.

In another embodiment, the wireless earpieces 302 may be utilized by professional entertainers (e.g., DJ's, speakers, performers, photographers, etc.) so they have their hands and bodies free to perform various other tasks associated with their work. In one example, the user 306 may give a verbal command, such as “prepare for my speech” with a corresponding head nod prepares the wireless earpieces 302 to receive streamed audio content through the microphones of the wireless earpieces for communication to the peripheral 304. Thus, when the user 306 is ready to perform work, personal, or recreational activities, the user 306 may simply say “broadcast”, “sound on”, or perform a head nod either of which may be detected by the wireless earpieces 302. The commands and associated actions may be trained and preprogrammed by the user 306 utilizing any number of user interfaces. As noted, any number of pre-commands may also be utilized to prepare the wireless earpieces 302 for receiving the actual commands sent to the peripheral 304.

In another embodiment, the peripheral 304 may represent a fitness tracking device (e.g., heart rate monitor, smart watch, implantable medical device, blood pressure cuff, smart wrist band, smart headband, medical monitoring device, etc.) with a fitness tracking application being initiated or executed in response to commands received through the wireless earpieces 302. For example, a verbal command to “track my calories” may send a command from the wireless earpieces 302 to the fitness tracking device (peripheral 304).

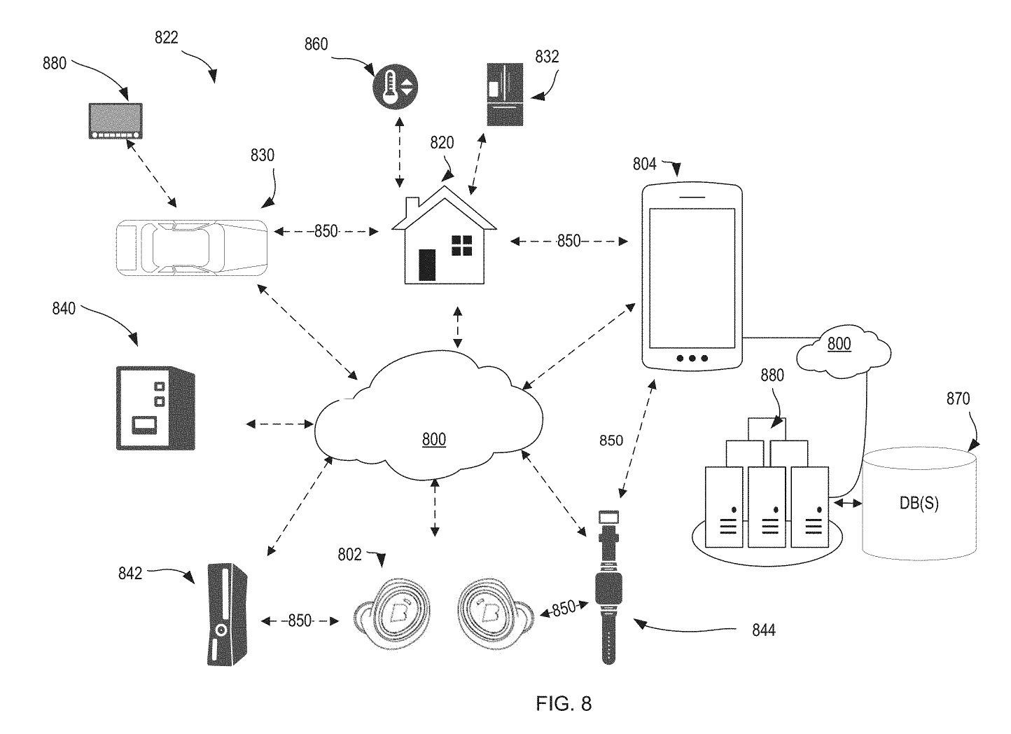

The wireless earpieces 302 may also communicate with any number of other peripherals. For example, the peripherals may be integrated with a home, structure, vehicle, mass transportation system, laboratory, gym, outdoor venue or other location or environment, such as the IoT network 822 shown in FIG. 8. The wireless earpieces 302 may also function as stand-alone devices or may communicate with the peripheral 304 to receive streamed or discrete content. For example, content may be streamed or otherwise communicated from the peripheral 304 to the wireless earpieces 302. In one embodiment, the wireless earpieces 302 include processors, memories, and sensors allow each of the wireless earpieces 302 to function and otherwise operate independent of each other as well as other devices. In another embodiment, the peripheral 304 and/or peripherals 118 (FIG. 1), 830, 820, 804, 844, 842, 840, 880, 832 and 860 (FIG. 8) include processors, memories, and sensors allowing each of the peripherals to function and otherwise operate independent of each other as well as other devices for edge computing.

The wireless earpieces 302 may communicate utilizing the wireless connection 314. The wireless connection 314 may represent a low power radio frequency or electromagnetic signal, such as NFMI, may be used to send signals between the wireless earpieces 302. For example, the connection 314 may synchronize audio content played by the first wireless earpiece and the second wireless earpiece. Similarly, the connection 316 may be established between one or more of the wireless earpieces 302 and the peripheral 304 to stream content, communicate data and messages, record biometric measurements, record environmental data, perform communications, perform commands, and so forth.

The connection 316 is amplified, boosted, or enhanced to facilitate communication between the wireless earpieces 302 and the peripheral 304 through the wireless connection 316. In one embodiment, the wireless earpieces 302 may switch between utilizing an NFMI connection (and the associated transceivers) as the wireless connection 314 to utilizing a Bluetooth, Wi-Fi, cellular, or other radio frequency or optical connection.

In one embodiment, the wireless earpieces 302 may have one or more transceivers utilized to communicate over greater distances. The type of connection and distance thresholds may expand as processors, memories, integrated circuits, circuit boards, chips and transceivers continue to be further miniaturized (e.g., nanotechnology, ultracapacitors, graphene embodiments, etc.). As shown, the wireless connection 314 may only need to communicate a small distance associated with a width of the head of the user 306. The wireless transceivers of the wireless earpieces 302 may dynamically adjust the wireless connection 314 and the wireless connection 316 based on the required transmission distance as well as the connection quality (e.g., throughput, error, latency, lag, etc.). The distance between the users may vary between a few feet to tens or hundreds of feet (or more) depending on the wireless connections 314, 316 being utilized. For example, when utilizing Bluetooth transceivers, a typical viable range between the wireless transceivers of the wireless earpieces 302 may have a maximum range between about 300-400 feet (e.g., Bluetooth low energy, Bluetooth 5, etc.). In another example, when utilizing cell transceivers, the range may be increased to a maximum distance of between 1-6 miles.

The wireless connection 316 may be established between the first wireless earpiece and the peripheral 304 automatically or as directed by the user 306. One or both wireless earpieces 302 may be configured for communication with the peripheral 304. For example, the wireless earpieces 302 may communicate amongst themselves utilizing the wireless connection 314 and one of the wireless earpieces 302 (e.g., a master device, communicating device, etc.) may communicate with the peripheral 304 through the wireless connection 316. As a result, communications between each of the wireless earpieces 302 and the peripheral 304 (e.g., sent and received) may be synchronized through one or both wireless earpieces 302. In other embodiments, additional users and wireless earpieces may be similarly synchronized or communicate with each other.

FIG. 4 is a block diagram of a wireless earpiece system 400 in accordance with an illustrative embodiment. As previously noted, the wireless earpieces 402 may be referred to or described herein as a pair (wireless earpieces) or singularly (wireless earpiece). The description may also refer to components and functionality of each of the wireless earpieces 402 collectively or individually. In one embodiment, the wireless earpiece system 400 may enhance communications and functionality of the wireless earpieces 402. In one embodiment, the wireless earpiece system 400 or wireless earpieces 402 may communicate directly or through one or more networks (e.g., Wi-Fi, mesh networks, cell networks, IoT network, Internet, etc.).

As shown, the wireless earpieces 402 may be wirelessly linked to the peripheral 404. For example, the peripheral 404 may represent a wireless speaker. The peripheral 404 may also represent a gaming device, tablet computer, vehicle system (e.g., GPS, speedometer, pedometer, entertainment system, etc.), media device, smart watch, laptop, smart glass, camera, or other electronic devices. User input, commands, and communications may be received from either the wireless earpieces 402 or the peripheral 404 for implementation on either of the devices of the wireless earpiece system 400 (or other externally connected devices). Communications between the wireless earpieces 402 and the peripheral 404 may be unidirectional or bidirectional.

In some embodiments, the peripheral 404 may act as a logging tool for receiving information, data, or measurements made by the wireless earpieces 402 together or separately. For example, the peripheral 404 may receive or download biometric data from the wireless earpieces 402 in real-time for a user utilizing the wireless earpieces 402. As a result, the peripheral 404 may be utilized to store, display, and synchronize data for the wireless earpieces 402 as well as manage communications. For example, the peripheral 404 may display pulse, proximity, location, oxygenation, distance, calories burned, and so forth as measured by the wireless earpieces 402. The peripheral 404 may be configured to receive and display an interface (e.g., touch screen, soft buttons, switches, toggles, physical buttons, etc.), selection elements, and alerts indicate conditions for sharing communications. For example, the wireless earpieces 402 may utilize factors, such as changes in motion or light, distance thresholds between the wireless earpieces 402 and/or peripheral 404, signal activity, user orientation, user speed, user location, environmental factors (e.g., temperature, humidity, noise levels, proximity to other users, etc.) or other automatically determined or user specified measurements, factors, conditions, or parameters to implement various features, functions, and commands.

The peripheral 404 may also include any number of optical sensors, touch sensors, microphones, and other measurement devices (sensors 417) may provide feedback or measurements the wireless earpieces 402 may utilize to determine an appropriate mode, settings, or enabled functionality. The wireless earpieces 402 and the peripheral 404 may have any number of electrical configurations, shapes, and colors and may include various circuitry, connections and other components.

In one embodiment, one or both wireless earpieces 402 may include a battery 408, a processor 410, a memory 412, a user interface 414, a physical interface 415, a transceiver 416, and sensors 417. The peripheral 404 may have any number of configurations and include components and features like the wireless earpieces 402 as are known in the art. The sharing functionality and logic implemented as part of the processor 410, user interface, or other hardware, software, or firmware of the wireless earpieces 402 and/or peripheral 404.

The battery 408 is a power storage device configured to power the wireless earpieces 402. In other embodiments, the battery 408 may represent a fuel cell, thermal electric generator, piezo electric charger, solar units, thermal power generators, ultra-capacitor, or other existing or developing power generation and storage technologies. The processor 410 preserves the capacity of the battery 408 by reducing unnecessary utilization of the wireless earpieces 402 in a full-power mode when there is little or no benefit to the user (e.g., the wireless earpieces 402 are sitting on a table or temporarily lost). The battery 408 or power of the wireless earpieces are preserved for when being worn or operated by the user. As a result, user satisfaction with the wireless earpieces 402 is improved and the user may be able to set the wireless earpieces 402 aside at any moment knowing battery life is automatically preserved by the processor 410 and functionality of the wireless earpieces 402. In addition, the battery 408 may use just enough power for the transceiver 416 for communicating across a distance separating users of the wireless earpieces 402.

The processor 410 is the logic controlling the operation and functionality of the wireless earpieces 402. The processor 410 may include circuitry, chips, and other digital logic. The processor 410 may also include programs, scripts, and instructions may be implemented to operate the processor 410. The processor 410 may represent hardware, software, firmware, or any combination thereof. In one embodiment, the processor 410 may include one or more processors. The processor 410 may also represent an application specific integrated circuit (ASIC) or field programmable gate array (FPGA). In one embodiment, the processor 410 may execute instructions to manage the wireless earpieces 402 including interactions with the components of the wireless earpieces 402, such as the user interface 414, transceiver 416, and sensors 417.

The processor 410 may utilize data and measurements from the transceivers 416 and sensors 417 to measure user input, determine distances between the wireless earpieces 402 and the peripheral 404, and determine whether the wireless earpieces 402 are being utilized by different users. For example, distance, biometrics, user input, and other application information, data, and measurements may be utilized to determine whether a peripheral command is implemented by the processor 410 and other components of the wireless earpieces 402. The processor 410 may control actions implemented in response to any number of measurements from the sensors 417, the transceiver 416, the user interface 414, or the physical interface 415 as well as user preferences may be user entered or other default preferences. For example, the processor 410 may initialize a peripheral management mode in response to any number of factors, conditions, parameters, measurements, data, values, or other information specified within the user preferences or logic. The processor 410 may control the various components of the wireless earpieces 402 to implement the peripheral management mode.

The processor 410 may implement any number of processes for the wireless earpieces 402, such as facilitating communications, listening to music, tracking biometrics or so forth. The wireless earpieces 402 may be configured to work together or completely independently based on the needs of the users. For example, the wireless earpieces 402 may be used by two different users at one time to control a single peripheral 404 or multiple peripherals. In one embodiment, each of the wireless earpieces 402 may not include all the components as shown. For example, only one of the wireless earpieces 402 may include a transceiver 416 for communicating with the peripheral 404. In another example, the wireless earpieces 402 may not include sensors 417, but may instead utilize buttons, selectors, or other input devices included in the user interface 414 to control the management and operation of the wireless earpieces 402. The wireless earpieces 402 may also represent headphones or an integrated portion of headphones.

The processor 410 may also process user input to determine commands implemented by the wireless earpieces 402 or sent to the peripheral 404 through the transceiver 416. Specific actions may be associated with user input (e.g., voice, tactile, orientation, motion, gesture, etc.). For example, the processor 410 may implement a macro allowing the user to associate frequently performed actions with specific commands/input implemented by the wireless earpieces 402. A training process or training mode may be utilized by the processor 410 to associate user input/commands with commands sent to the peripheral 404. The user input may include a combination of factors, such as a voice input and head gesture/orientation. The user input may specify one or more inputs as well as biometrics utilized. In one embodiment, the wireless earpieces 402 may require the user is identified before processing any commands.

In one embodiment, a processor included in the processor 410 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 412 is a hardware element, device, or recording media configured to store data or instructions for subsequent retrieval or access later. The memory 412 may represent static or dynamic memory. The memory 412 may include a hard disk, random access memory, cache, removable media drive, mass storage, or configuration suitable as storage for data, instructions, and information. In one embodiment, the memory 412 and the processor 410 may be integrated. The memory 412 may use any type of volatile or non-volatile storage techniques and mediums. The memory 412 may store information related to user input/commands, peripheral actions associated with the commands, communications identifiers, authorizations, as well as the status of a user, wireless earpieces 402, peripheral 404, and other peripherals, such as a tablet, smart glasses, a smart watch, a smart case for the wireless earpieces 402, a wearable device, and so forth. In one embodiment, the memory 412 may display instructions, programs, drivers, or an operating system for controlling the user interface 414 including one or more LEDs or other light emitting components, speakers, tactile generators (e.g., vibrator), and so forth. The memory 412 may also store thresholds, conditions, signal or processing activity, proximity data, and so forth.

The transceivers 416 are components including both a transmitter and receiver which may be combined and share common circuitry on a single housing. The transceivers 416 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. In one embodiment, the transceivers 416 may represent a hybrid or multi-mode transceiver supporting several different communications with distinct devices simultaneously. For example, the transceivers 416 may communicate with the peripheral 404 or other systems utilizing wired interfaces (e.g., wires, traces, etc.), NFC, or Bluetooth communications as well as inter-device between the wireless earpiece 402 utilizing NFMI. The transceivers 416 may also detect amplitudes and signal strength to infer distance, directions, orientation, and positions with respect to the wireless earpieces 402 as well as the peripheral 404. For example, commands may only be sent from the wireless earpieces 402 if the peripheral 404 is within range or able to receive the command from the wireless earpieces 402.

The components of the wireless earpieces 402 may be electrically connected utilizing any number of wires, contact points, leads, busses, wireless interfaces or so forth. In addition, the wireless earpieces 402 may include any number of computing and communications components, devices or elements which may include busses, motherboards, printed circuit boards, circuits, chips, sensors, ports, interfaces, cards, converters, adapters, connections, transceivers, displays, antennas and other similar components. The physical interface 415 is hardware interface of the wireless earpieces 402 for connecting and communicating with the peripheral 404 or other electrical components, devices, or systems.

The physical interface 415 may include any number of pins, arms, or connectors for electrically interfacing with the contacts or other interface components of external devices or other charging or synchronization devices. For example, the physical interface 415 may be a micro USB port. In one embodiment, the physical interface 415 is a magnetic interface automatically coupling to contacts or an interface of the peripheral 404. In another embodiment, the physical interface 415 may include a wireless inductor for charging the wireless earpieces 402 without a physical connection to a charging device. In addition, the physical interface 415 may be utilized to synchronize, link, or connect the wireless earpieces 402 with the peripheral 404 for sending and receiving commands, communications, and content as well as implementing the associated peripheral actions.

The physical interface 415 may allow the wireless earpieces 402 to be utilized when not worn as a remote microphone and sensor system (e.g., seismometer, thermometer, light detection unit, motion detector, etc.). For example, measurements, such as noise levels, temperature, movement, and so forth may be detected by the wireless earpieces 402 even when not worn. The wireless earpieces 402 may be utilized as a pair, independently or when stored in a smart case. Each of the wireless earpieces 402 may provide distinct sensor measurements as needed. In one embodiment, the smart case may include hardware (e.g., logic, battery, transceiver, etc.) to integrate as part of a mesh network, repeater, router, or extender. For example, the smart case may be utilized as a node or relay within a mesh network for sending and receiving communications, such as peripheral commands.

The user interface 414 is a hardware interface for receiving commands, instructions, or input through the touch (haptics) of the user, voice commands or predefined motions. The user interface 414 may further include any number of software and firmware components for interfacing with the user. The user interface 414 may be utilized to manage and otherwise control the other functions of the wireless earpieces 402 including mesh communications. The user interface 414 may include the LED array, one or more touch sensitive buttons or portions, a miniature screen or display or other input/output components (e.g., the user interface 414 may interact with the sensors 417 extensively). The user interface 414 may be controlled by the user or based on commands received from the peripheral 404 or a linked wireless device. In one embodiment, peripheral management modes and processes may be controlled by the user interface, such as recording communications, receiving user input for communications, sharing biometrics, queuing communications, sending communications, receiving user preferences for the communications and so forth. The user interface 214 may also include a virtual assistant for managing the features, functions and components of the wireless earpieces 402.

In one embodiment, the user may provide user input for the user interface 414 by tapping a touch screen or capacitive sensor once, twice, three times, or any number of times. Similarly, a swiping motion may be utilized across or in front of the user interface 414 (e.g., the exterior surface of the wireless earpieces 402) to implement a predefined action. Swiping motions in any number of directions or gestures may be associated with specific activities or actions of the wireless earpieces 402 (or the peripherals 404), such as play music, pause, fast forward, rewind, activate a virtual assistant, listen for commands, initiate fitness tracking, take a picture, stop recording, activate biometric tracking, send automated messages, control appliances, report biometrics, enabled sharing communications, and so forth.

As previously noted, the swiping motions may be similarly utilized to control actions and functionality of the peripheral 404 or other external peripheral devices (e.g., smart television, camera array, smart watch, vehicle systems, displays, processing systems, etc.). The user may also provide user input by moving his head in a direction or motion or based on the user's position or location. For example, the user may utilize voice commands, head gestures, or touch commands to change the processes implemented by the wireless earpieces 402 as well as the processes executed, or content displayed by the peripheral 404. The user interface 414 may also provide a software interface including any number of icons, soft buttons, windows, menus, windows, links, graphical display units, and so forth.

In one embodiment, the sensors 417 may be integrated with the user interface 414 to detect or measure the user input. For example, infrared sensors positioned against an outer surface of the wireless earpieces 402 may detect touches, gestures, or other input as part of a touch or gesture sensitive portion of the user interface 414. The outer or exterior surface of the user interface 414 may correspond to a portion of the wireless earpieces 402 accessible to the user when the wireless earpieces are worn within the ears of the user.

In addition, the sensors 417 may include pulse oximeters, accelerometers, thermometers, barometers, radiation detectors, gyroscopes, magnetometers, global positioning systems, beacon detectors, inertial sensors, photo detectors, miniature cameras, and other similar instruments for detecting user biometrics, environmental conditions, location, utilization, orientation, motion, and so forth. The sensors 417 may provide measurements or data may be utilized to select, activate or otherwise utilize the mesh network. Likewise, the sensors 417 may be utilized to awake, activate, initiate or otherwise implement actions and processes utilizing conditions, parameters, values or other data within the user preferences. For example, the optical biosensors within the sensors 417 may determine whether the wireless earpieces 402 are being worn and when a selected gesture to activate a peripheral action is provided by the user.

The peripheral 404 may include components similar in structure and functionality to those shown for the wireless earpieces 402. The computing device may include any number of processors, batteries, memories, busses, motherboards, chips, transceivers, peripherals, sensors, displays, cards, ports, adapters, interconnects, and so forth. In one embodiment, the peripheral 404 may include one or more processors and memories for storing instructions. The instructions may be executed as part of an operating system, application, browser, or so forth to implement the features herein described. In one embodiment, the wireless earpieces 402 may be magnetically, wirelessly, or physically coupled to the peripheral 404 to be recharged, linked, paired, synchronized or to be stored. In one embodiment, the peripheral 404 may include applications executed to enable peripheral management based on communications from the wireless earpieces 402. For example, a peripheral management application may be executed by the wireless earpieces 402 and the peripheral 404 to synchronize commands and content communicated between the devices and executed by peripheral 404. Separate applications executed by the wireless earpieces 402 and the peripheral 404 may function as a single application to enhance functionality, interface and interact, and perform the processes herein described.

The peripheral 404 may be utilized to adjust the user preferences including settings, thresholds, activities, conditions, environmental factors, and so forth utilized for and by the wireless earpieces 402 and the peripheral 404. For example, the peripheral 404 may utilize a graphical user interface allows the user to more easily specify any number of conditions, values, measurements, parameters, and factors utilized to perform communications and share content between the wireless earpieces 402.

In another embodiment, the peripheral 404 may also include sensors for detecting the location, orientation, and proximity of the wireless earpieces 402 to the peripheral 404. The wireless earpieces 402 may turn off communications to the peripheral 404 in response to losing a status, link, connection, or heart beat communication to preserve battery life and may only periodically search for a connection, link, or signal to the peripheral 404 or the other wireless earpiece(s). The wireless earpieces 402 may also turn off components, enter a low power or sleep mode, or otherwise preserve battery life in response to no interaction with the user for a period, no detection of the presence of the user (e.g., touch, light, conductivity, motion, etc.) or so forth.

As originally packaged, the wireless earpieces 402 and the peripheral 404 may include peripheral devices such as charging cords, power adapters, inductive charging adapters, solar cells, batteries, lanyards, additional light arrays, speakers, smart case covers, transceivers (e.g., Wi-Fi, cellular, etc.) or so forth. In one embodiment, the wireless earpieces 402 may include a smart case (not shown). The smart case may include an interface for charging the wireless earpieces 402 from an internal battery as well as through a plugged connection. The smart case may also utilize the interface or a wireless transceiver to log utilization, biometric information of the user, and other information and data. The smart case may also be utilized as a repeater, a signal amplifier, relay, or so forth between the wireless earpieces 402 or as part of a mesh network (e.g., a node in the mesh network).

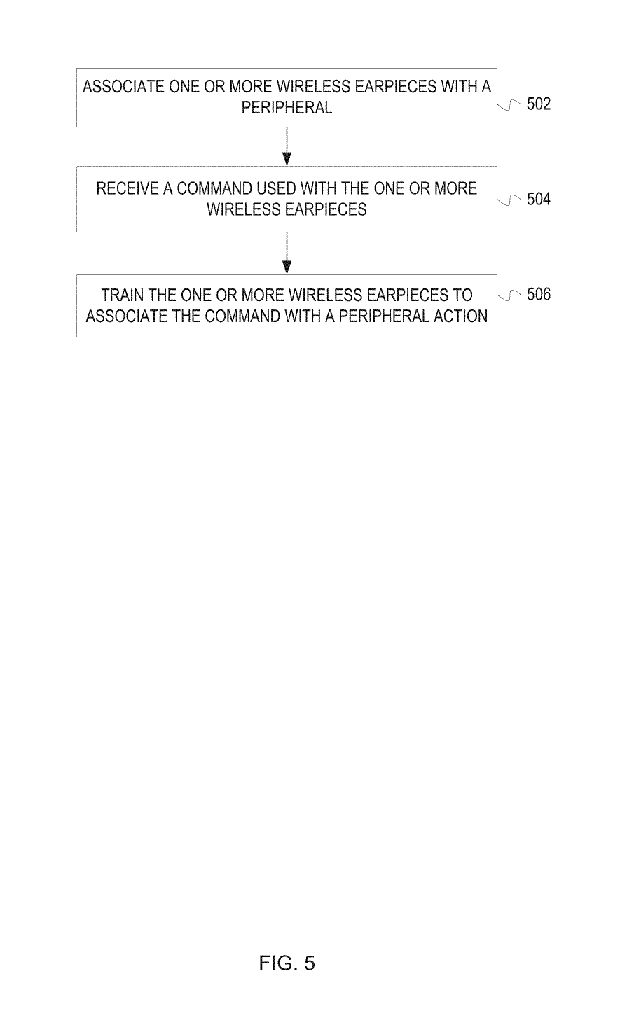

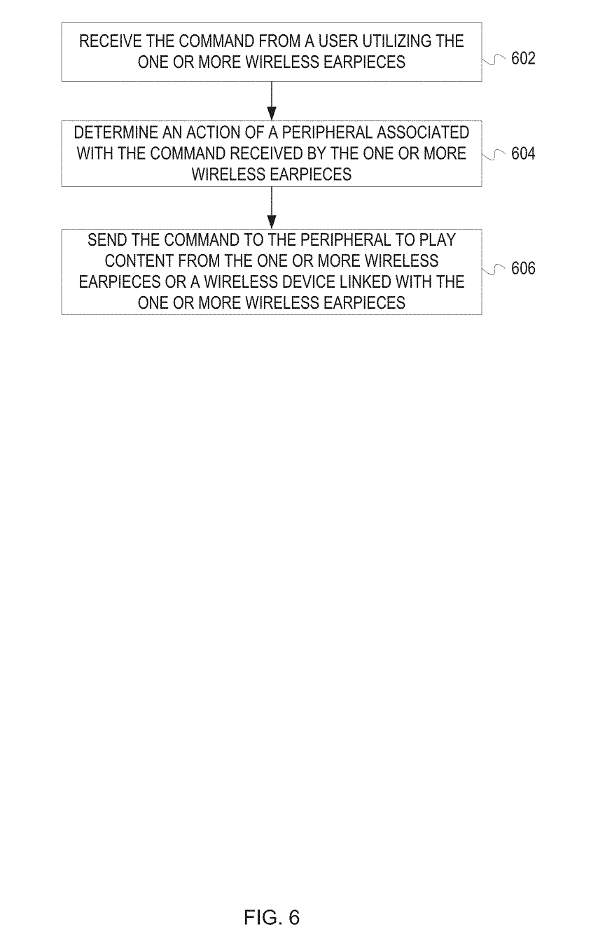

FIG. 5 is a flowchart of a process for associating commands from one or more wireless earpieces with a peripheral in accordance with an illustrative embodiment. In one embodiment, the process of FIGS. 5 and 6 may be implemented by each of the wireless earpieces of a set/pair independently or jointly. In another embodiment, the process of FIGS. 5 and 6 may be implemented by one or more wireless earpieces in communication with one peripheral (jointly the “system”) or with several peripherals. The one or more wireless earpieces and one or more peripherals may represent devices, such as those shown in FIGS. 1, 2, 3, 4 & 8. In fact, each of the peripherals and/or wireless earpieces of FIGS. 1, 2, 3, 4 & 8 can be interchanged without departing from the spirit of the invention. In one embodiment, the process of FIG. 5 may represent a process for training the one or more wireless earpieces to associate one or more commands with a peripheral action. The peripheral device may also require similar association or training.

In one embodiment, the process may begin by associating one or more wireless earpieces with a peripheral (step 502). As noted, one wireless earpiece or several wireless earpieces may be associated with the peripheral device. The peripheral device may represent any number of electronic devices configured to wirelessly communicate with the wireless earpieces, such as cameras, cell phones, computers, security systems, exercise equipment, gaming devices, personal entertainment devices, smart appliances, virtual assistants, vehicle systems and smart wearables (e.g., smart glasses, smart watches, headphones, etc.). The associating process may include performing Bluetooth pairing, providing identifiers (e.g., device names/nicknames, IP addresses, IMEIs, serial numbers, or other hardware or software identifiers), physical-based pairing, or other association, linking or communication processes.

Next, the wireless earpieces receive a command used with the one or more wireless earpieces (step 504). The command may represent any number or types of user input, feedback, or commands such as verbal commands, head motions, hand or body gestures and tactile feedback (e.g., taps, swipes, etc.). In one embodiment, the command may be manually provided by a user wearing the one or more wireless earpieces. In another embodiment, the command may be automatically determined by the one or more wireless earpieces based on the biometrics, behavior, actions, activities, or other measurements gathered from the user.

Next, the wireless earpieces are trained to associate the command with a peripheral action (step 506). The command may indicate which of several different peripherals and associated actions are received by the peripheral and implemented as an action, respectively. The training may represent a process utilized to associate one or more commands with the peripheral action. For example, a verbal command and gesture may be received sequentially, simultaneously, or concurrently to implement a specified command. The action and sequence may be specified by the user. The training may allow the user to specify several commands are associated with each of several peripheral actions for a specified peripheral device.

In another embodiment, the wireless earpieces may be configured to automatically be paired with the peripheral based on proximity (e.g., distance thresholds), user actions/activities, environmental conditions, utilized applications, user preferences or so forth.

FIG. 6 is a flowchart of a process for sending commands to the peripheral associated with the one or more wireless earpieces in accordance with an illustrative embodiment. The process of FIG. 6 may be combined with the process of FIG. 5 or may represent additional processes and functionality may be implemented. In one embodiment, the process of FIG. 5 may be implemented to prepare the one or more wireless earpieces and peripheral for the process of FIG. 6. The processes may be performed sequentially, simultaneously, interleaved, concurrently, or so forth. The process of FIG. 6 may begin by receiving the command from a user utilizing the one or more wireless earpieces (step 602). As previously noted, the command may be received as user input or other measurements performed by the sensors and advanced components of the one or more wireless earpieces. The command may also represent a combination of inputs or readings to ensure the command is properly received for processing.

Next, the one or more wireless earpieces determine an action of a peripheral associated with the command received by the one or more wireless earpieces (step 604). During step 604, the command is processed by the one or more wireless earpieces for communication to the designated peripheral. For example, an identifier associated with the one or more wireless earpieces may be utilized to address the command to the correct peripheral. Similarly, any number of different communications protocols, standards, or formats may be required by the peripheral to be properly received, processed, and implemented.

Next, the one or more wireless earpieces send the command to the peripheral to play content from the one or more wireless earpieces or a wireless device linked with the one or more wireless earpieces (step 606). The content may include audio, video, text, or other signals, messages, streams, or data content. The content may be discrete or ongoing, such as real-time communications or inputs sensed by the one or more wireless earpieces. In one embodiment, the content may be communicated directly from the one or more wireless earpieces to the peripheral. In another embodiment, the content may be communicated indirectly from the one or more wireless earpieces through the wireless device (e.g., a smart phone linked or associated with the one or more wireless earpieces). The content may be routed through any number of electronic devices. For example, nodes, range extenders, repeaters, networks, a mesh network, or so forth may be utilized between the wireless earpieces and the peripheral.

In another embodiment, the one or more wireless earpieces may control or manage communication of the content from a wireless device, such as a smart phone, wireless content server, smart assistant (e.g., with or without an Internet connection), or so forth, to one or more peripherals. For example, the wireless device may also have a connection or link to the peripheral. In another example, the link may be shared between multiple devices (e.g., the wireless earpieces, the wireless device and the peripheral). In one embodiment, the peripheral(s) referred to in FIGS. 5 and 6 may represent one or more peripherals whether functioning and connected as stand-alone devices, connected devices, networked devices, or so forth.

In another embodiment, the one or more wireless earpieces may switch between management or communications with several peripherals. For example, the one or more wireless earpieces may automatically pair with the nearest peripheral in an environment with numerous peripherals. In another example, the one or more wireless earpieces may connect to one of the peripherals in response to a user command (e.g., voice command, head gesture, etc.). As a result, the user does not have to physically pair/unpair the one or more wireless earpieces and the peripherals. The user input, intentions, or applicable conditions may be sensed to perform the pairing and unpairing processes automatically. For example, in response to a user nodding at a second speaker system, the one or more wireless earpieces may unlink from a first speaker system and pair itself with the second speaker system.

The illustrative embodiments may take the form of an entirely hardware embodiment, an entirely software embodiment (including firmware, resident software, micro-code, etc.) or an embodiment combining software and hardware aspects generally referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, including a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless or another communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely or partially on a user's wireless device, wireless earpieces, or computer, as a stand-alone software package, partly on the user's device(s) and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

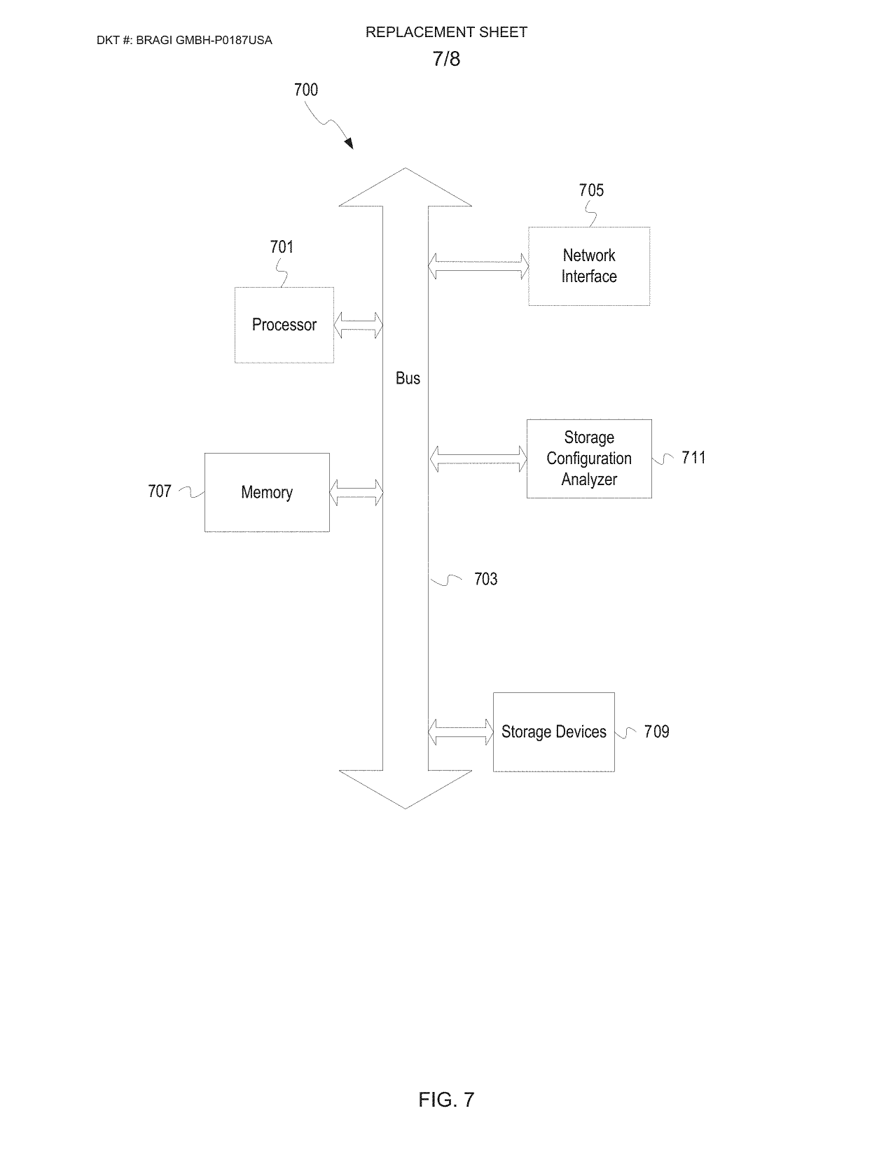

FIG. 7 depicts a computing system 700 in accordance with an illustrative embodiment. For example, the computing system 700 may represent a device, such as the wireless device 104 or peripherals 118 of FIGS. 1, 2, 3, 4 & 8. The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 706 (e.g., an ATM interface, an Ethernet interface, a Frame Relay interface, SONET interface, wireless interface, etc.), and a storage device(s) 709 (e.g., optical storage, magnetic storage, etc.).

The system memory 707 embodies functionality to implement all or portions of the embodiments described above. The system memory 707 may include one or more applications or sets of instructions for implementing a peripheral management mode with one or more wireless earpieces. In one embodiment, specialized peripheral management software may be stored in the system memory 707 and executed by the processor unit 702. The peripheral management software may be utilized to manage user preferences (e.g., settings, automated processes, etc.), communications, input, and device actions, synchronize devices, or so forth. As noted, the management application or software may be similar or distinct from the application or software utilized by the wireless earpieces. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701. The computing system 700 may further include any number of optical sensors, accelerometers, magnetometers, microphones, gyroscopes, temperature sensors, and so forth for verifying user biometrics, or environmental conditions, such as motion, light, or other events may be associated with the wireless earpieces or their environment.

The illustrative embodiments may be utilized to control and manage content (e.g., audio, video, data, etc.) played, displayed, or communicated by one or more peripherals as managed through the wireless earpieces. For example, music may be streamed from the wireless earpieces to one or more wireless speakers whether directly or through an intermediary device (e.g., smart phone, repeater, etc.). For example, the wireless earpieces may control a smart phone synchronized with a Bluetooth speaker. In one embodiment, the wireless earpieces may automatically connect to a nearest peripheral. For example, the wireless earpieces and the peripheral may have been previously paired. In another embodiment, the wireless earpieces may connect to a peripheral based on user input, feedback, or instructions, such as a directional gesture, voice command, head motion, or so forth. The wireless earpieces may be linked, connected, or paired (or disconnected, unpaired) in real-time based on user input. For example, the wireless earpieces may switch between a first link with a first peripheral to a second link with a second peripheral.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

With reference to FIG. 8 a wireless earpiece with a network for control of IoT in an illustrative embodiment is shown. As discussed above, wireless earpieces 802 may also control peripheral devices through the IoT 822. IoT 822 is the network of physical devices, vehicles 830, home appliances 832 and other items embedded with electronics, software, sensors, actuators and network connectivity which enables these objects to connect and exchange data. Each peripheral device is uniquely identifiable through its embedded computing system but can inter-operate within the existing Internet infrastructure. The IoT 822 allows objects to be sensed or controlled remotely across existing network infrastructure 800, creating opportunities for more direct integration of the physical world into computer-based systems, and resulting in improved efficiency, accuracy and economic benefit in addition to reduced human intervention. When IoT 822 is augmented with sensors and actuators, the technology becomes an instance of the more general class of cyber-physical systems, which also encompasses technologies such as smart grids, virtual power plants, smart homes 820, intelligent transportation and smart cities.

Peripheral devices in the IoT 822, can refer to a wide variety of devices such as vending machine 840, gaming system 842, smart watch 844, automobiles 830 with built-in sensors, smart home 820 or mobile device 804. These devices collect useful data with the help of various existing technologies and then autonomously flow the data between other devices.

Wireless earpieces 802, as discussed above, can link and pair with a peripheral device within the IoT 822 as discussed above with reference to FIGS. 5 & 6. The peripheral devices shown in FIG. 8 can be a gaming system 842, smart watch 844, mobile device 804, smart home 820, vehicle 830 and a vending machine 840. These items are but a small list of the possible IoT devices discussed in detail above. While only a handful of peripheral devices have been shown in the present application, it is fully contemplated most any device could be a peripheral device without departing from the spirit of the invention.

Wireless earpieces 802 can identify and couple with any identifiable peripheral device, either locally through direct communications 850 or through an internet network 800. Once wireless earpieces 802 are paired with the peripheral devices, wireless earpieces 802 can control functionality and/or communicate with these peripheral devices. Furthermore, wireless earpieces 802 can be used to control other peripheral devices through the IoT 822.

A user could send voice instructions through the wireless earpieces 802 to smart home 820 to have HVAC system 860 turn the temperature down in smart home 820 and have smart home 820 find out from refrigerator 832 if any grocery shopping needed to be done. Smart home 820 would then send a message back to the wireless earpieces 802 informing the user the task was complete and providing a grocery list the user can store until they reach the supermarket. This application could also be performed with a smart assistant (e.g., Alexa®, Siri®, Google Home® and Cortana®) which speaks directly to the wireless earpieces 802 and allows the user to speak directly through a speaker coupled to the smart assistant to directly speak to the smart home 820 or to instruct the smart assistant to speak to or directly control the smart home 820.

A user can purchase a snack treat out of vending machine 840 through voice commands to wireless earpieces 802. The use can instruct what snack they would like, such as “A7” or “Nutter-Butter Bar”. When prompted by vending machine 840, wireless earpiece 802 could provide credit/debit information stored within memory 412 to vending machine 840.

A user could also instruct their gaming system 842 to begin downloading a game the user discovered while away from home. The user could use a voice command to the wireless earpieces 802 to give the instructions over network 800 of IoT 822 and gaming system 842 could begin the ordering and downloading of a game.

A user could also send a text via smart watch 844. A use could give an initial instruction to communicate with the smart watch, saying “Smart Watch” and then begin giving instructions to dictate and send a text. Or perhaps the user would like to know their biometric readings during their last workout or to have their biometric readings from their last workout stored on database 870 for storage and analysis. The user would simply instruct smart watch 844 through voice or any other type of command to wireless earpiece 802 to have the smart watch 844 perform these functions.

A user could also ask vehicle 830 what the mileage is on vehicle 830 and if vehicle 830 needs servicing. The user could also instruct vehicle 830 to have radio/navigation unit 880 to obtain directions for the user's next trip before the user gets to the vehicle. All through network 800 of IoT 822 controlled by wireless earpieces 802.

The wireless earpieces 802 may also utilize edge computing to make operation efficient and seamless. Edge computing is a method of optimizing cloud-computing systems by performing data processing at the edge of the network, near the source of the data. For purposes of the present invention, each peripheral 118, mobile device 104/804, vehicle 830, smart home 820, smart watch 844, gaming system 842 and vending machine 840 (peripheral devices) all have the computing system 700 discussed thoroughly above. Because each peripheral device has a computing system data processing can be performed at each device, thus reducing the communications bandwidth needed between the peripheral devices and the central data center 880 by performing analytics and knowledge generation at or near the source of the data; the peripheral devices.

Edge computing pushes applications, data and computing power (services) away from centralized points to the logical extremes of a network. Edge computing replicates fragments of information across distributed networks of web servers, which may spread over a vast area. As a technological paradigm, edge computing is also referred to as mesh computing, peer-to-peer computing, autonomic (self-healing) computing, grid computing and by other names implying non-centralized, node-less availability.

The previous detailed description is of a small number of embodiments for implementing the invention and is not intended to be limiting in scope. The following claims set forth several the embodiments of the invention disclosed with greater particularity.

What is claimed is:

1. A method for controlling an Internet of Things (IoT) from one or more wireless earpieces, the method comprising:
associating the one or more wireless earpieces with the IoT;
receiving user input from a user wearing the one or more wireless earpieces; and
sending a command to a peripheral within the IoT to execute an instruction from the one or more wireless earpieces or a wireless device linked with the one or more wireless earpieces.

2. The method of claim 1, wherein the associating is a pairing process between the one or more wireless earpieces and the peripheral.

3. The method of claim 1, further comprising:
verifying the user is authorized to utilize the peripheral.

4. The method of claim 1, wherein the user input includes one or more of voice input, gesture controls, and tactile input.

5. The method of claim 1, further comprising:
associating the user input with the command.

6. The method of claim 1, wherein the command is specific to the peripheral.

7. The method of claim 1, wherein the command is sent to the peripheral through the wireless device linked with the one or more wireless earpieces.

8. The method of claim 1, wherein the peripheral is a wireless speaker.

9. The method of claim 8, further comprising:
automatically connecting to the peripheral as a nearest one of a plurality of peripherals.

10. A wireless earpiece, comprising:
a frame for fitting in an ear of a user;
a processor controlling functionality of the wireless earpiece;
a plurality of sensors read user input from the user;
a transceiver communicating with an Internet of Things (IoT) network;
wherein the processor associates the wireless earpieces with the IoT, receives user input from a user wearing the wireless earpieces, and sends a command for a peripheral within the IoT to perform the command from the wireless earpieces or from a second peripheral linked with the wireless earpieces.

11. The wireless earpiece of claim 10, wherein the processor verifies the user is authorized to utilize the peripheral.

12. The wireless earpiece of claim 10, wherein the peripheral performs data processing on an onboard computing system.

13. The wireless earpiece of claim 12, wherein all peripherals within the IoT perform data processing on an onboard computing system in an edge computing architecture.

14. The wireless earpiece of claim 10, wherein the processor further receives a confirmation the action was performed.

15. The wireless earpiece of claim 10, wherein the action is one or more of initiating a recording, taking a picture, and opening an application.

16. Wireless earpieces comprising:
a frame for fitting in an ear of a user;
a processor operably coupled to the frame controlling functionality of the wireless earpiece;
a user interface operably coupled to the processor receiving user input from a user wearing the wireless earpieces;
a memory operably coupled to the user interface and the processor, wherein the commands received by the user associates the wireless earpieces with an Internet of Things (IoT) network, and
a transceiver operably coupled to the processor sends a command for a peripheral within the IoT network to perform the command from the wireless earpieces or a wireless device linked with the wireless earpieces.

17. The wireless earpieces of claim 16, wherein the processor automatically connects to the peripheral as a nearest one of a plurality of peripherals.

18. The wireless earpieces of claim 16, wherein the processor connects to the peripheral in response to a command from the user.

19. The wireless earpieces of claim 16, wherein the processor verifies the user is authorized to utilize the peripheral.

20. The wireless earpieces of claim 16, wherein the processor streams the content from the wireless earpieces or the wireless device to the peripheral, and wherein the peripheral is a wireless speaker.
